(19) United States
(12) Patent Application Publication
(10) Pub. No.: US 2014/0379465 A1
(43) Pub. Date: Dec. 25, 2014

(54) Providing Advertisement Opportunities During Presentation of Shopping List

(71) Applicant: Robert Brazell, Salt Lake City, UT (US)

(72) Inventor: Robert Brazell, Salt Lake City, UT (US)

(21) Appl. No.: 14/315,218

(22) Filed: Jun. 25, 2014

Related U.S. Application Data
(60) Provisional application No. 61/839,305, filed on Jun. 25, 2013.

(51) Int. Cl. G06Q 30/02

(52) U.S. Cl. CPC G06Q 30/0253
USPC 705/14.51

(57) ABSTRACT

The present invention provides advertisement opportunities during presentation of a shopping list, while displaying ingredients of a recipe, or during a similar display of items to a consumer. When a type of product is displayed to a consumer as part of a shopping list, recipe, or other similar display, the present invention can provide a product manufacturer or supplier with the opportunity to advertise its product to the consumer in conjunction with the display. In this way, the present invention can enable product manufacturers or suppliers to provide targeted advertisements for a product at the moment when consumers are making a decision to purchase a product. Because these targeted advertisements can be more effective at influencing a consumer to purchase a particular product, a manufacturer or supplier can spend less money to promote its products than when other forms of general advertising are used.

### CROSS-REFERENCE TO RELATED APPLICATIONS

This application claims the benefit of U.S. Provisional Patent Application No. 61/839,305 which was filed on Jun. 25, 2013.

### BACKGROUND

An average person may spend many hours planning meals, shopping for ingredients for the meals, and then preparing the meals. Much of this time is spent identifying meals that the person will like that are also nutritious. For example, a person may research which foods provide good nutrition, and then search for recipes that include the foods as ingredients. Similarly, a person may identify meals that the person believes he will like and then research whether the meal is healthy or ways to prepare the meal to be healthier. Many people also often desire to try new foods to identify undiscovered foods that they may like.

In either case, once the person identifies certain foods or ingredients that he would like to try, he must then locate where the foods or ingredients are available and travel to one or more locations to purchase them. If the foods or ingredients are not common, the person may have to travel a long distance or to many locations to obtain each of the desired foods or ingredients.

Oftentimes, a person does not have the time or resources available to identify and obtain foods or ingredients that can be used to prepare a meal that the person may like. Even if the person has sufficient time or resources, he may not desire to spend the time or resources necessary to identify, obtain, and prepare such meals.

### BRIEF SUMMARY

The present invention extends to methods, systems, and computer program products for providing advertisement opportunities during presentation of a shopping list, while displaying ingredients of a recipe, or during a similar display of items to a consumer. When a type of product is displayed to a consumer as part of a shopping list, recipe, or other similar display, the present invention can provide a product manufacturer or supplier with the opportunity to advertise its product to the consumer in conjunction with the display.

In this way, the present invention can enable product manufacturers or suppliers to provide targeted advertisements for a product at the moment when consumers are making a decision to purchase a product such as when consumers are compiling a shopping list or selecting a recipe to prepare. Because these targeted advertisements can be more effective at influencing a consumer to purchase a particular product, a manufacturer or supplier can spend less money to promote its products than when other forms of general advertising are used.

In one embodiment, the present invention is implemented as a method for displaying an advertisement of a product to a user in conjunction with the display of the product in a recipe or shopping list. A recipe or a shopping list is displayed to a user, the recipe or shopping list including one or more products. A first product of the one or more products included in the recipe or shopping list is identified as a first type of product. A manufacturer or supplier of the first type of product is identified as having provided an advertisement for a brand of the first type of product. An advertisement is then displayed for the brand of the first type of product, the advertisement being displayed in conjunction with the display of the recipe or the shopping list.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer environment in which the present invention can be implemented;

FIG. 2 illustrates a user using a computer system within the example computer environment to communicate with an avatar to receive meal recommendations;

FIGS. 3A-3E illustrate example displays that can be provided to enable a user to interact with an avatar;

FIG. 4 illustrates a flowchart of an example method for providing a meal recommendation to a user;

FIG. 5 illustrates an example user interface for displaying a shopping list that includes a brand of a product;

FIGS. 6A-6J illustrate various screenshots of an example user interface that can be displayed to receive input and identify a meal recommendation for a consumer, and within which an advertisement for a particular brand of a product can be displayed;

FIG. 7 illustrates an example user interface of a digital retail store in which a consumer can select products for inclusion in a shopping list; and

FIG. 8 illustrates a flowchart of an example method for displaying an advertisement of a product to a user in conjunction with the display of the product in a recipe or shopping list

### DETAILED DESCRIPTION

The present invention extends to methods, systems, and computer program products for providing advertisement opportunities during presentation of a shopping list, while displaying ingredients of a recipe, or during a similar display of items to a consumer. When a type of product is displayed to a consumer as part of a shopping list, recipe, or other similar display, the present invention can provide a product manufacturer or supplier with the opportunity to advertise its product to the consumer in conjunction with the display.

In this way, the present invention can enable product manufacturers or suppliers to provide targeted advertisements for a product at the moment when consumers are making a decision to purchase a product such as when consumers are compiling a shopping list or selecting a recipe to prepare. Because these targeted advertisements can be more effective at influencing a consumer to purchase a particular product, a manufacturer or supplier can spend less money to promote its products than when other forms of general advertising are used.

In one embodiment, the present invention is implemented as a method for displaying an advertisement of a product to a user in conjunction with the display of the product in a recipe or shopping list. A recipe or a shopping list is displayed to a user, the recipe or shopping list including one or more products. A first product of the one or more products included in the recipe or shopping list is identified as a first type of product. A manufacturer or supplier of the first type of product is identified as having provided an advertisement for a brand of the first type of product. An advertisement is then displayed for the brand of the first type of product, the advertisement being displayed in conjunction with the display of the recipe or the shopping list.

Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computer Environment

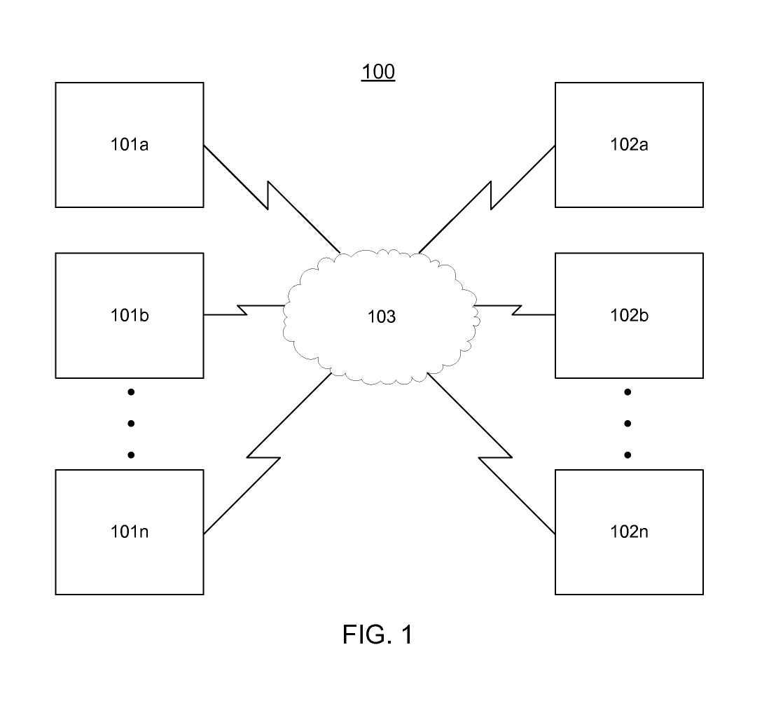

FIG. 1 illustrates an example computer environment 100 in which the present invention can be implemented. Computer environment 100 includes server computing systems 101a-101n and client computing devices 102a-102n which are connected via a network 103. Computer environment 100 in a typical environment can represent the internet.

Server computing systems 101a-101n represent any type of computer system connected to network 103 that stores content accessible from one or more of client computer devices 102a-102n. For example, each of server computing systems 101a-101n can comprise any number of computer systems or resources such as a single server or a cloud of interconnected computer resources. In other words, the present invention should not be limited to any particular computer or network configuration or infrastructure.

Client computing devices 102a-102n can represent any type of computing device capable of communicating with any of server computing systems 101a-101n over network 103. Examples of client computing devices 102a-102n include desktop computers, laptop computers, tablets, mobile phones, other smart electronic devices, etc. Although in most implementations, network 103 will be the internet, any type of network or direct connection between a client computer device 102 and a server computing system 101 could be used in addition to or in place of the internet.

Providing Meal Recommendations Using an Avatar with Artificial Intelligence

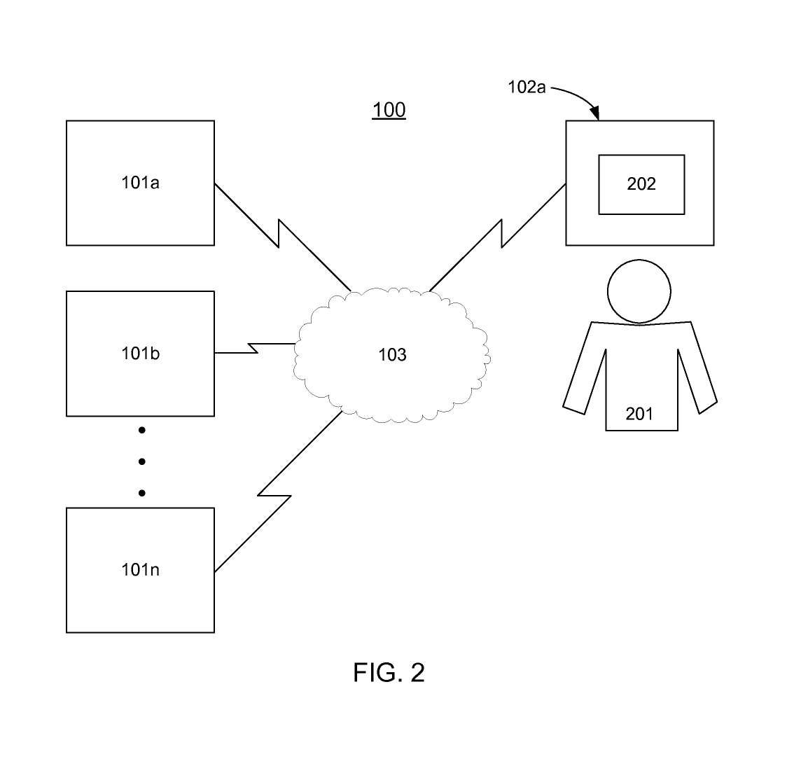

FIG. 2 represents computer environment 100 when a user 201 is using client computing device 102a to communicate with an avatar 202 in accordance with one or more embodiments of the invention. Avatar 202 comprises computer executable logic for obtaining information from user 201, searching for and identifying relevant information available via network 103, and using the information obtained from the user and via network 103 to present meal recommendations to user 201. In some embodiments, avatar 202 can be displayed on a computer device as a person, character, animal, or other figure which interacts with user 201.

Although avatar 202 is shown as being located on client computing device 102a, it is to be understood that not all of the logic for implementing avatar 202 needs to be located on client computing device 102a. For example, avatar 202 can be based on one or more of server computer systems 101a-101n (e.g. server-based or cloud-based) with a user interface being provided locally on client computing device 102a to interface with user 201. Similarly, logic for implementing avatar 202 can be stored locally on client computing device 102a while the information learned by avatar 202 can be hosted partially or entirely on one or more of server computing systems 101a-101n. Of course, logic for implementing avatar 202 can be provided on multiple of client computing devices 102a-102n such as when user 201 uses a home computer, a work computer, and a mobile phone/tablet to interface with avatar 202. Accordingly, the specific manner in which avatar 202 is hosted is not essential to the invention.

Avatar 202 continually receives information via network 103 and from user 201 to enable avatar 202 to learn to make meal decisions for user 201 that user 201 would likely make if he were making the decision himself. The information received from user 201 can include initial information received from user 201 (e.g. preferences of user 201, health or diet requirements or goals, other life related conditions for user 201 including but not limited to sleep quality, sleep quantity, work hours, work related stress, school related stressors, social stressors, etc.), as well as user 201's responses to previously presented recommendations.

The information identified over network 103 can include recipes or ingredients for meals, related recipes or ingredients, substitutions for ingredients or meals, nutritional content or benefits of ingredients or meals, or any other type of information that is considered in determining what to eat for a meal. In some embodiments, avatar 202 can use user 201's responses to recommendations to identify certain ingredients, qualities, or characteristics of meals or foods that user 201 is likely to prefer, and can formulate recommendations based on such information. For example, avatar 202 can identify common ingredients or qualities in meals that user 201 has identified that he has enjoyed and can identify (e.g. over network 103) other meals that share these ingredients or qualities.

Such recommendations can be based not only on user 201's preference for the taste of certain foods, but can also be based on one or more criteria related to user 201's health, diet, lifestyle goals, conditions, stressors or requirements. For example, avatar 202 can learn (either through direct input or via inference based on user 201's responses) that user 201 has a diet goal to eat a reduced amount of carbohydrates. Avatar 202 can use such information to identify foods or meals that user 201 would likely choose based on the flavor and content of the food.

Recommendations can also be made based on information about user 201's schedule (e.g. by interfacing with user 201's calendar). For example, if avatar 202 identifies a meal to recommend to user 201, but the meal requires a substantial amount of time to prepare, avatar 202 can recommend that the meal be prepared on a day in which user 201 has more free time before the meal. Similarly, if user 201 is scheduled to exercise after a meal, avatar 202 can identify a meal that is lighter or that provides additional carbohydrates.

Recommendations can also be made based on information about user 201's lifestyle stressors (e.g. long hours of work, sleep deprivation, quality of sleep, work stressors, finals in college, by interfacing with user 201's calendar, other applications utilized by the user 201, biometric and activity level of user 201 from other user 201 applications, user's 201 social stressors may be acquired from social networking sites frequented by user 201, etc.). For example, if avatar 202 identifies a meal to recommend to user 201, but the meal requires a substantial amount of time to prepare, avatar 202 can recommend that the meal be prepared on a day in which user 201 has more free time before the meal. Similarly, if user 201 is scheduled to exercise after a meal, avatar 202 can identify a meal that is lighter or that provides additional carbohydrates. Similarly, if avatar 202 receives data related to user's 201 activity level from a third party application or apparatus, avatar 202 can identify meals that provide the appropriate ratios of macronutrients as well as micronutrients.

Recommendations can also be made based on information about user 201's finances (e.g. by interfacing with user 201's bank account or other financial information). For example, if avatar 202 identifies a meal to recommend to user 201, but the ingredients required to prepare the meal are more expensive, avatar 202 can recommend that the meal be prepared when user 201 has sufficient funds to cover the expense.

Avatar 202 can identify recommendations to make to user 201 for a specified duration of time. For example, avatar 202 may identify recommendations for a one week period. In addition to recommending the meals for the week, avatar 202 can also identify all ingredients that would be required to prepare each meal and present these ingredients to user 201. In this way, user 201 can easily identify which ingredients he will need to buy to prepare meals during the upcoming week.

Further, in some embodiments, avatar 202 can also be provided information regarding which ingredients user 201 already has. Avatar can use this information to identify only the ingredients that user 201 will need to purchase to prepare the meals. In this way, avatar 202 can provide a shopping list to user 201.

In some embodiments, avatar 202 can also be configured to automatically obtain necessary ingredients for recommended meals. For example, once avatar 202 has identified each ingredient user 201 will need that he does not already have, avatar 202 can order the necessary ingredients (e.g. via an online grocer).

By tracking which ingredients are required to prepare recommended meals as well as which ingredients and quantity of ingredients user 201 already has on hand, avatar 202 can proactively order necessary ingredients to ensure that user 201 always has what is needed to prepare recommended meals.

In some embodiments, avatar 202 can track the quantity of ingredients based on a response from user 201 regarding whether a meal or certain portion of a meal was prepared or modified. For example, if avatar 202 recommended a meal, at some later time, avatar 202 can prompt user 201 to confirm whether user 201 prepared and/or enjoyed the meal. If user 201 confirms that he prepared the meal, avatar 202 can automatically update the tracked quantities of any ingredients that would have been used to prepare the meal. For example, if the meal required one cup of flour, avatar 202 can decrement a cup from the tracked quantity of flour that user 201 has. If the quantity of flour falls below some threshold, avatar 202 can automatically order more or recommend purchasing more.

In some embodiments, avatar 202 may utilize a photograph of user's 201 pantry, cupboards, refrigerators, freezer or food storage to establish what ingredients user 201 is in possession of. The user interface can analyze, classify and identify each of the products in the photograph. The user interface can utilize the photograph to identify the type, brand, size, etc. of products in the photograph. For example, the user interface can be configured to identify text, logos, or other designs on products in the photograph.

When a product is identified in the photograph, an advertisement, coupon, or other information can be displayed on or by the user interface. For example, if a generic brand of cereal is identified in the photograph, the user interface can determine that the name brand cereal is on sale or identify a coupon for the name brand cereal that will likely entice the customer to purchase the name brand. Similarly, the user interface can recommend products that go with a product identified in the photograph.

In some embodiments, the user interface can use the photograph or a series of photographs to create an inventory of the customer's purchased products. The user interface or avatar 202 can use the inventory to create a shopping list for the customer, identify coupons for items on the shopping list, etc.

In addition to providing a shopping list to user 201, avatar 202 can also use information obtained via network 103 to identify a location or multiple locations where the items on the shopping list can be obtained. Further, avatar 202 can also recommend one or more particular locations based on the price of the items at the particular locations. For example, avatar 202 can identify which retail locations provide the items on the list at the lowest total cost, or may identify, for each item, the retail location selling the item at the lowest price. Avatar 202 can take into account any coupons, offers, sales, or other discounts in identifying retail locations.

In some embodiments, avatar 202 can also identify a route within a retail location to optimize user 201's visit to the retail location. For example, avatar 202 can provide a map to guide user 201 through a retail location. Avatar 202 can also track items as the user obtains them within the retail location. For example, user 201 can scan a barcode on an item or otherwise identify an item to a client computing device 102 on which avatar 202 is executing or with which avatar 202 can communicate. Based on this identification of items, avatar 202 can provide advertising, coupons, or other information related to the item, the retail location, or some other entity (e.g. by displaying an advertisement or coupon on the client computing device related to the item, another item, or the retail location).

In some embodiments user 201 is user interface can provide a store map service that can identify the location of a product/multiple products within a store. The content displayed in user interface can be generated by customer computing device (e.g. using information received from server system, from customer, or from another source) or by server system. For example, user interface can display a map of a store layout that includes aisles, shelves, displays, checkouts, entries, exits, restrooms, and other store features. A store layout can also display different sections or departments of the store such as a produce section, a meat section, a freezer section, or other sections of a grocery store.

User interface can provide different levels of detail regarding the location of a product within a store. For example, the user interface can identify the aisle where the product is located, or a specific location on the aisle. Additional product information can also be provided such as the type, size, or brand of the product. This information can be provided on the map or can be otherwise displayed or audibly output to the customer.

In some embodiments, user interface can also provide directions from the customer's current location to the location of a desired product. For example, the user interface can display a route on the map to the location of the desired product. In some embodiments, the user interface can provide visual or audible directions.

In some embodiments, user interface can provide a path through the store based on a shopping list submitted by the customer. In some embodiments, the path can be the most efficient route (e.g. the shortest distance through the store while acquiring all of the items on the shopping list or quickest route through the store while acquiring all of the items on the shopping list) through the store. The determination of the most efficient route can be based on factors such as high-traffic areas, physical structures such as stairs, escalators, or elevators, the location of restrooms, the location where the customer parked a car or will catch public transportation, etc.

In some embodiments, the user interface can present multiple potential paths to the user along with an estimated time for following each path. This estimation can be updated periodically or continuously based on the user pace or delays along the path.

In some embodiments, the calculation of a route can consider various product-specific factors such as whether any products need to remain hot or cold, or whether any products need to be placed at the top or bottom of the shopping cart. The user interface can also provide a cost for each product or a total cost for all products on the shopping list as well as recommendations for lowering the cost such as coupons or alternative products that are cheaper.

In some embodiments, the user interface can provide advertisements to the customer as the customer moves along the route. Because the user interface knows the route the customer will take as well as the type of products the user intends to purchase, the user interface can promote products along the planned route. These advertisements can be customized based on the customer's personal information, purchase history, products in the shopping list, or the estimated amount of money the customer will spend during the current shopping trip.

In some embodiments, the user interface can also identify which checkout line the customer should use to check out most quickly. Which checkout line is recommended can be based on historical or real-time data, the path through the store, or the exit the customer is likely to use.

In some embodiments, avatar 202 can categorize meals into various categories. For example, categories can be created based on ingredients, meal type, style, weight, etc. For example, various criteria can be associated with each meal including when the meal may be eaten (breakfast, lunch, dinner, snack, etc.), the healthfulness of the meal (e.g. unhealthy, healthy, very healthy, completely healthy, etc.), the length of time required to prepare the meal and/or the length of time required to consume the meal (e.g. instant, 5-15 minutes, 15-30 minutes, 30-60 minutes, etc.).

These groupings of meals can be used by avatar 202 in determining which meal recommendations to provide to user 201. The logic for identifying a meal to recommend can be of various complexities which can be user configurable. For example, as described above, the selection of a meal recommendation can be based only on the user's indication of which meals he likes, in which case each group can be formed using only criteria of which meals user 201 likes.

In contrast, the selection of a meal recommendation can be based on many criteria including some or all of the ingredients, price or availability of the ingredients, a user's schedule, goals, or dietary restrictions, whether the user has indicated an interest to try new foods, etc. Accordingly, avatar 202 can consider many different criteria from one meal to the next when making a recommendation. The information used to identify a meal to recommend can be constantly changing as avatar 202 learns more about meal options as well as about the user's preferences, status, schedule, or any other information about the user.

In some embodiments, avatar 202 can identify meal recommendations based on information unique to user 201. In other words, the decision regarding which meal to recommend can be based solely on information about meals and the information about the user. However, in some embodiments, avatar 202 can use information regarding other user's preferences towards meals in determining whether to recommend a meal to the user. For example, avatar 202 can access information obtained about other users (e.g. by other avatars employed by other users) to identify common trends among users such as by identifying a particular meal that is preferred by user's sharing common characteristics with user 201.

In one example, avatar 202 can determine that user 201 enjoys meals sharing various characteristics and that user 201 is scheduled to exercise after the meal. Accordingly, avatar 202 can access information obtained by other avatars regarding meals sharing the various characteristics that were enjoyed by other users prior to exercising. Any other combination of criteria (whether specific to user 201 or to other users) could also be used to determine a meal to recommend.

By making recommendations, avatar 202 can relieve user 201 of making many of the daily decisions that he would otherwise have to make. In this way, user 201 can be freed to invest his time focusing on other matters. However, the effectiveness of avatar 202 in relieving user 201 of making these decisions depends greatly on user 201's willingness to follow the recommendations presented by avatar 202. Because avatar 202 increases the accuracy of its recommendations over time by learning more about user 201, user 201 is encouraged to follow avatar 202's recommendations and report his feedback to avatar 202 regarding these recommendations. In time, avatar 202 can accumulate sufficient information about user 201 to become highly accurate in recommending a meal that will not only be enjoyed by user 201, but that will also promote user 201's other goals, interests, or activities. As this accuracy increases, user 201 can become more and more confident in avatar 202's recommendation thus allowing avatar 202 to make the meal related decisions in user 201's life.

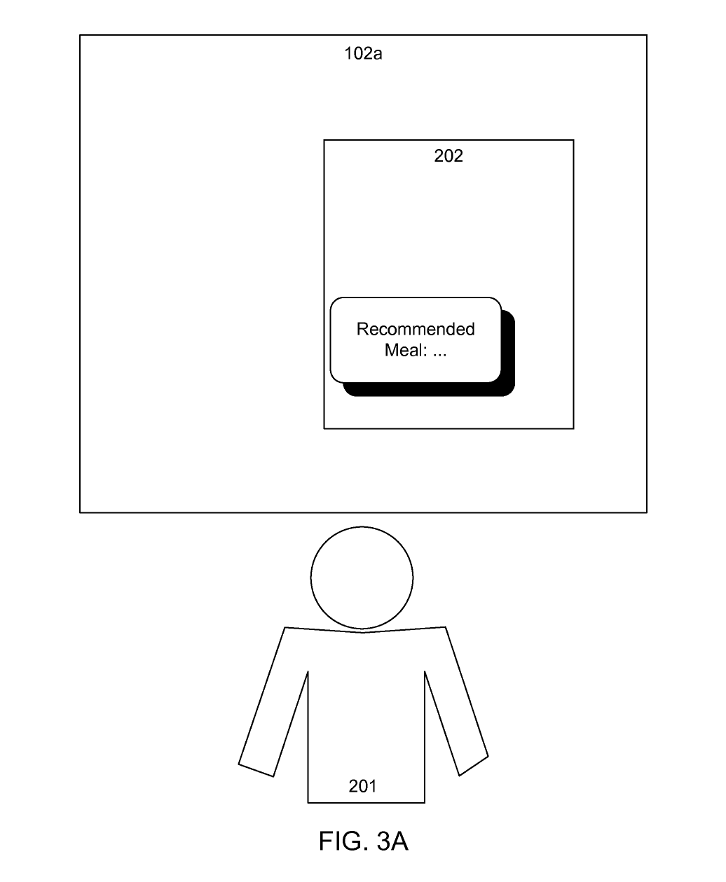

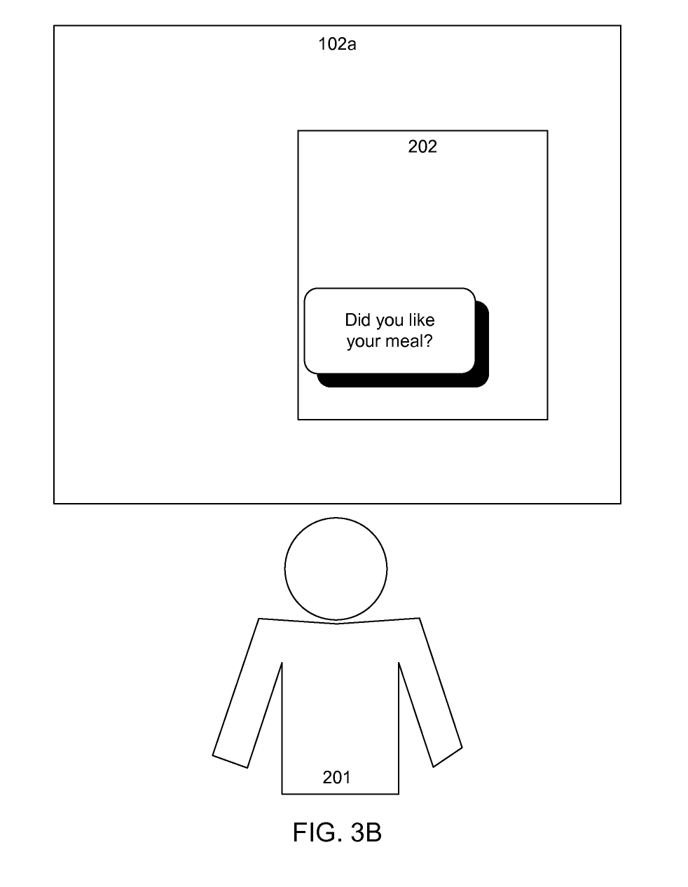

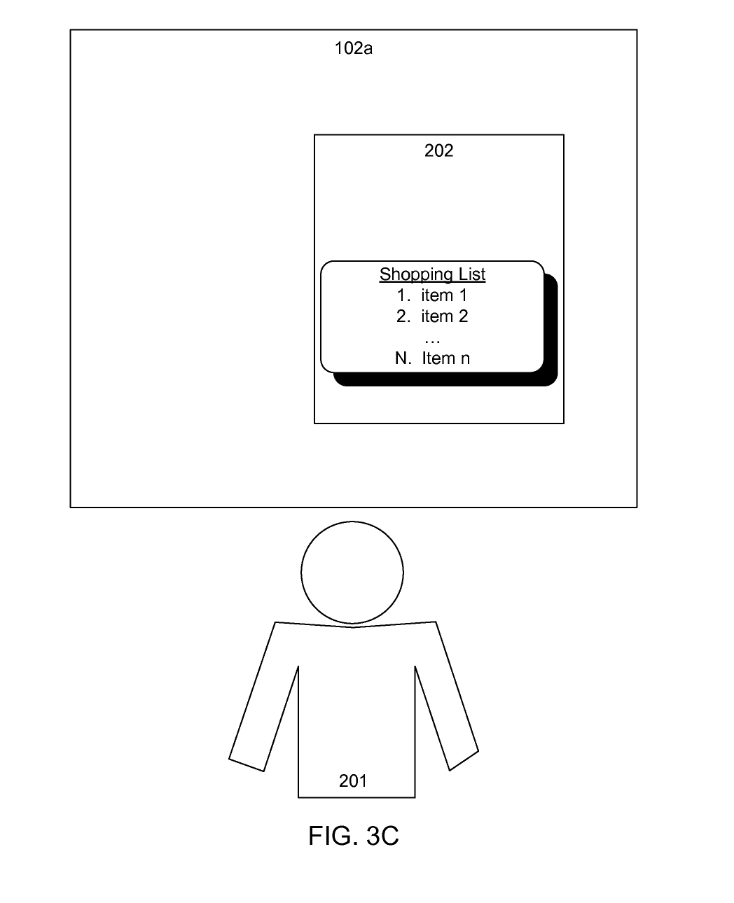

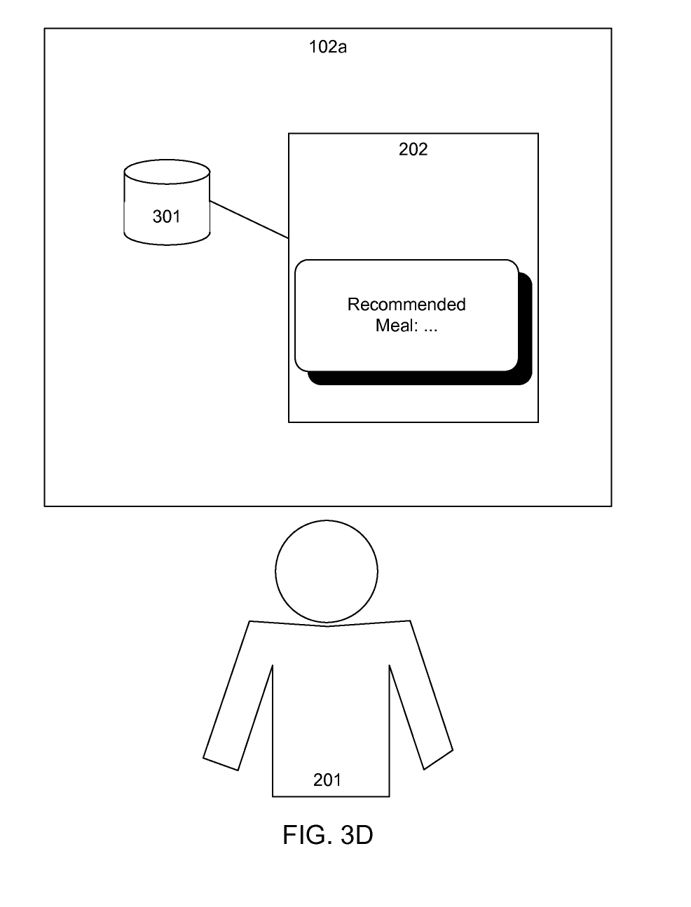

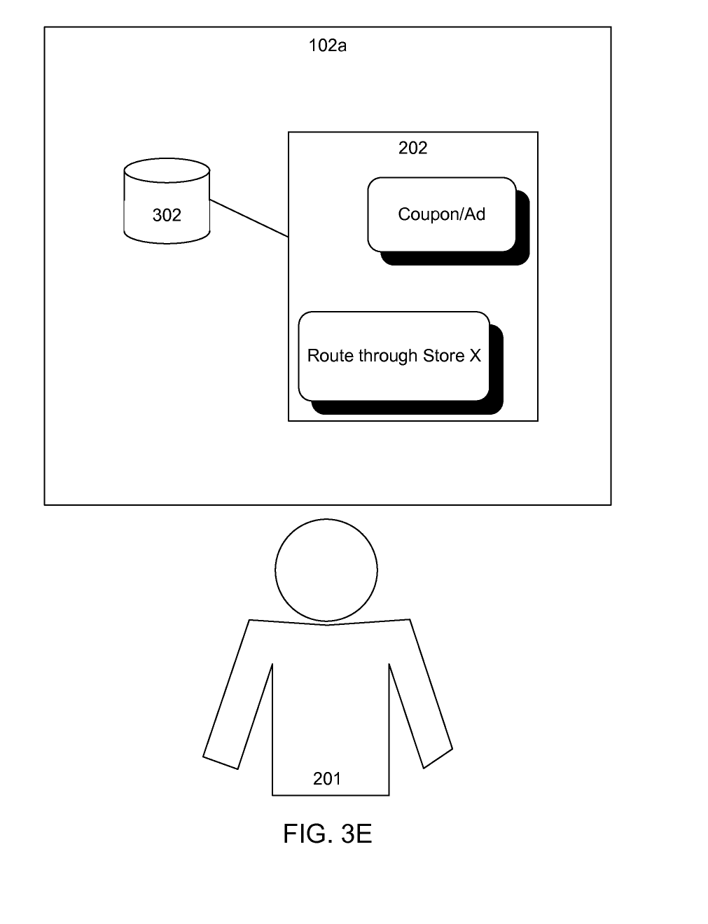

FIGS. 3A-3E present various user interfaces that represent examples of how avatar 202 can interact with user 201. FIGS. 3A-3E display avatar 202 being executed on client computing device 102a. In FIG. 3A, avatar 202 has displayed a meal recommendation to user 201. The meal recommendation can be made based on any combination of information described above including information about user 201, information about meals and their ingredients, as well as information about other users. In some embodiments, the meal recommendation can be in the form of a recipe, shopping list, and/or shopping route. Also, a meal recommendation, in some embodiments, can list the criteria used to select the meal recommendation, an option to request a different recommendation, and/or an option to provide feedback for the recommendation.

FIG. 3B illustrates an exemplary prompt that can be displayed by avatar 202 to request feedback from user 201 regarding a meal recommendation. In FIG. 3B, the prompt asks whether user 201 liked the meal. In some embodiments, a prompt can be displayed that asks whether user 201 prepared the meal (e.g. to update a quantity of ingredients that avatar 202 maintains), whether user 201 modified the meal in any way (e.g. by substituting ingredients, changing the quantity of any ingredients, etc.), whether the meal was appropriate for certain circumstances (e.g. before, during, or after certain activities, a status of user 201, etc.), etc. The feedback provided by user 201 can be used by avatar 202 in improving the quality of future meal recommendations.

FIG. 3C illustrates an exemplary shopping list that can be displayed to user 201. The shopping list can be displayed to user 201 in response to various input or circumstances (e.g. when user 201 has indicated a desire to prepare a recommended meal, when ingredients are needed for preparing a selected meal, when user 201 is shopping, etc.). The shopping list can display each item as well as a price, location, coupon, or other information for any item. The shopping list can also be customized based on an identified retail location. For example, if user 201 identifies a desire to shop at a particular retail location, the shopping list can be customized for the particular location. The shopping list can also include an option to request that avatar 202 order the items on the list for user 201 (e.g. via an online grocer or other retailer).

FIG. 3D illustrates that a database 301 can be accessed to determine recommendations. Database 301 can represent one or more databases that can be stored locally on client computing device 102a or on any other computing system accessible to avatar 202. Avatar 202 can update the content of database 301 as avatar 202 learns new information about user 201, meals, other users, etc.

FIG. 3E illustrates an exemplary display that avatar 202 can provide to inform user 201 of a route through a store as well as a coupon or advertisement that may be relevant to items on a shopping list or to the store. As shown, avatar 202 can access information in a database 302 to determine a route, coupon, ad, or other relevant information to display. Database 302 can represent a retail location's website or other storage location accessible by avatar 202, a third party mapping database, a coupon database, or any other source of information that avatar 202 can access to provide user 201 with assistance for shopping.

Example Method for Providing Meal Recommendations

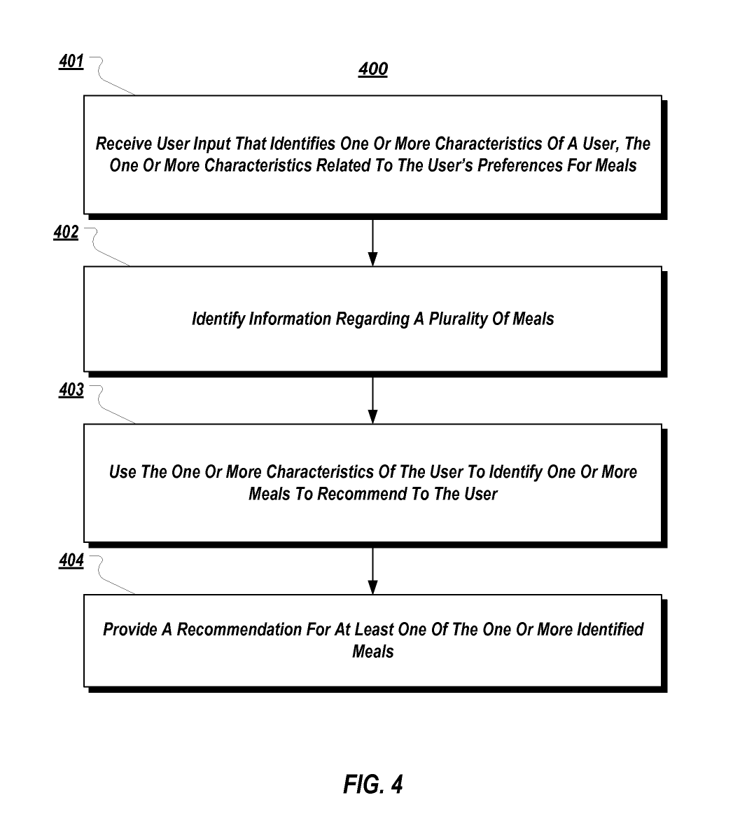

FIG. 4 illustrates a flowchart of an example method 400 for providing a meal recommendation to a user. Method 400 can be implemented on many different types of computer devices or systems. In some embodiments, method 400 can be implemented using an avatar to interact with the user. Method 400 will be described with reference to the Figures.

Method 400 includes an act 401 of receiving user input that identifies one or more characteristics of a user, the one or more characteristics related to the user's preferences for meals. For example, avatar 202 can receive user input from user 201 that specifies one or more foods or ingredients that user 201 likes, one or more meals that were previously recommended and enjoyed by user 201, etc.

Method 400 includes an act 402 of identifying information regarding a plurality of meals. For example, avatar 202 can identify information over network 103 or information stored locally related to the meals. The information can include ingredients of a food or meal, food or meals enjoyed by other users, nutritional information about a food or meal, etc.

Method 400 includes an act 403 of using the one or more characteristics of the user to identify one or more meals to recommend to the user. For example, avatar 202 can match the one or more characteristics of the user to characteristics identified for the one or more meals.

Method 400 includes an act 404 of providing a recommendation for at least one of the one or more identified meals. For example, avatar 202 can provide a recommendation to be displayed to user 201.

In some embodiments, after a recommendation of a meal is presented to a user, the user can provide feedback indicating whether the user enjoyed the recommended meal. Based on this feedback, the avatar can modify stored preferences of the user to enhance future meal recommendations. In this way, the avatar can continually improve the quality of its meal recommendations based on how the user has responded to previous meal recommendations.

In summary, embodiments of the present invention allow a user to employ an avatar to learn about the user's preferences for meals and to make meal recommendations based on these learned preferences. In this way, the user can be relieved from making many of the meal related decisions that are commonly required.

Providing Advertisement Opportunities During Presentation of Shopping List

The above description has presented various ways in which the present invention can provide meal recommendations to a consumer including presenting a recipe for a recommended meal or generating a shopping list of products the consumer would need to purchase to prepare a recommended meal. In some embodiments, the present invention can provide functionality for allowing a product manufacturer or supplier to present an advertisement to a consumer in conjunction with the display of a recipe, shopping list, or other similar display.

For example, as described above, based on information obtained from or about the consumer, avatar 202 can identify one or more products to be included in a shopping list for the consumer. These products can be products that the consumer will need to buy to prepare a recommended meal or products that the consumer has selected for inclusion in the shopping list whether or not the products are necessary for preparing a recommended meal. Similarly, based on information obtained from or about the consumer, avatar 202 can identify a recipe requiring one or more products to recommend to the consumer. In conjunction with the display of these products to the consumer, the present invention can provide the opportunity for a manufacturer or supplier to advertise its products matching those displayed.

For example, if a shopping list or recipe generated for a consumer includes brown rice, a manufacturer or supplier of brown rice can provide an advertisement for its brown rice. The advertisement can provide information about the manufacturer's or supplier's brown rice or, in some embodiments, can provide a discounted price for the brown rice that is available at one or more nearby retailers or a coupon for obtaining a discounted price on the brown rice. In this way, the manufacturer or supplier of the brown rice can attempt to influence the consumer's decision regarding which brown rice to purchase at a time when the consumer is likely to purchase brown rice.

In some embodiments, an advertisement that is displayed for a product (e.g. in a shopping list or recipe) can be selectable to allow the consumer to add the particular brand of product being advertised to the consumer's shopping list. For example, if the consumer selects the manufacturer's or supplier's advertisement for brown rice, the manufacturer's or supplier's brand of brown rice can be added to the consumer's shopping list. In some embodiments, any coupon or discounted price provided in the advertisement can be associated with the shopping list (e.g. within an account of the consumer such as a loyalty account at a retailer) so that the coupon or discounted price is applied when the consumer purchases the brand of brown rice.

Because the display of products (e.g. within a shopping list, recipe, etc.) can be performed on virtually any type of computing device, the display of advertisements in the manner described above can be provided at a most effective time to influence the consumer's purchasing decisions. For example, if the consumer is using a computing device at home to generate a shopping list prior to visiting a grocery store, the advertisement of a product can be displayed while the consumer's shopping list is being generated. Similarly, if the shopping list has already been generated, the advertisement can be displayed while the consumer is reviewing the shopping list such as prior to or while shopping. Likewise, if the consumer is reviewing recipes (whether recommended or otherwise) to identify ingredients that need to be purchased to prepare a recipe, an advertisement of an ingredient in the recipe can be displayed to influence the consumer to select the advertised ingredient for inclusion in a shopping list.

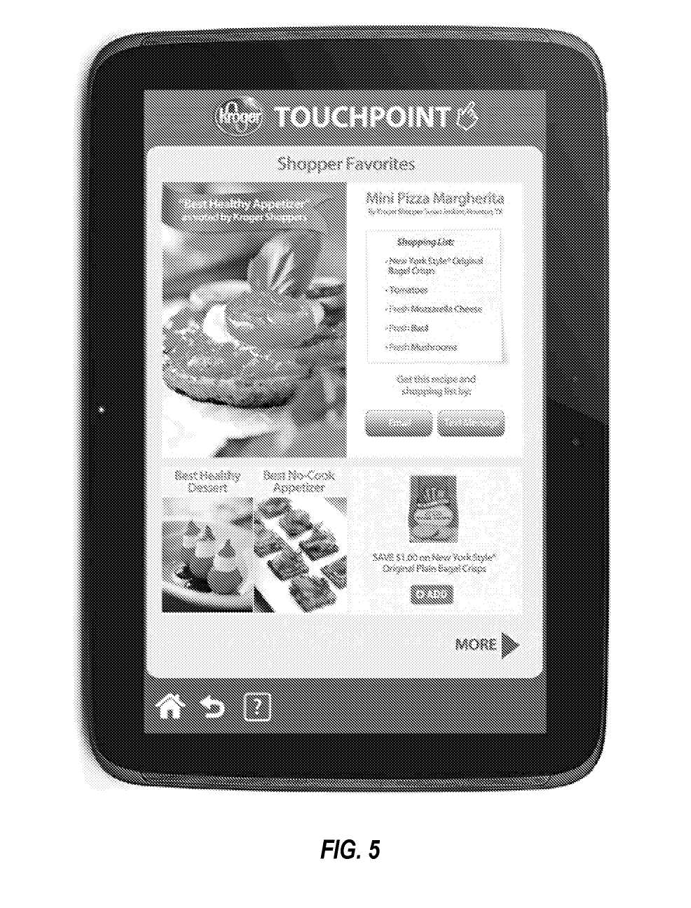

FIG. 5 illustrates an example computing device that includes a display of a shopping list that includes the ingredients required for preparing a mini pizza margherita appetizer. The shopping list includes bagel crisps, tomatoes, mozzarella cheese, basil, and mushrooms. As shown, the bagel crisps are specifically identified as New York Style Original Bagel Crisps. Accordingly, FIG. 5 illustrates an example where the consumer's shopping list has already been updated to reflect that the consumer selected an advertisement presented by the manufacturer of New York Style Original Bagel Crisps. For example, the shopping list could have been updated in response to the consumer selecting the coupon (or a similar add) for New York Style Original Bagel Crisps that appears directly below the shopping list.

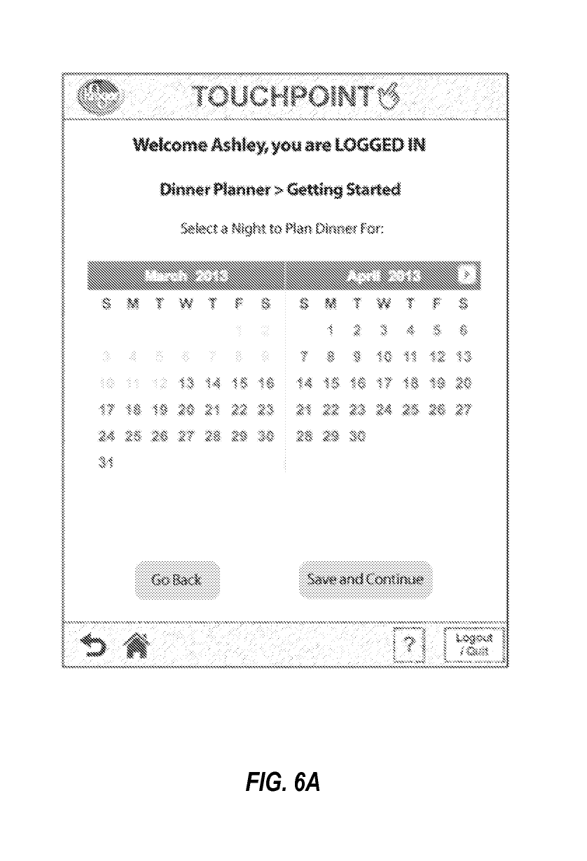

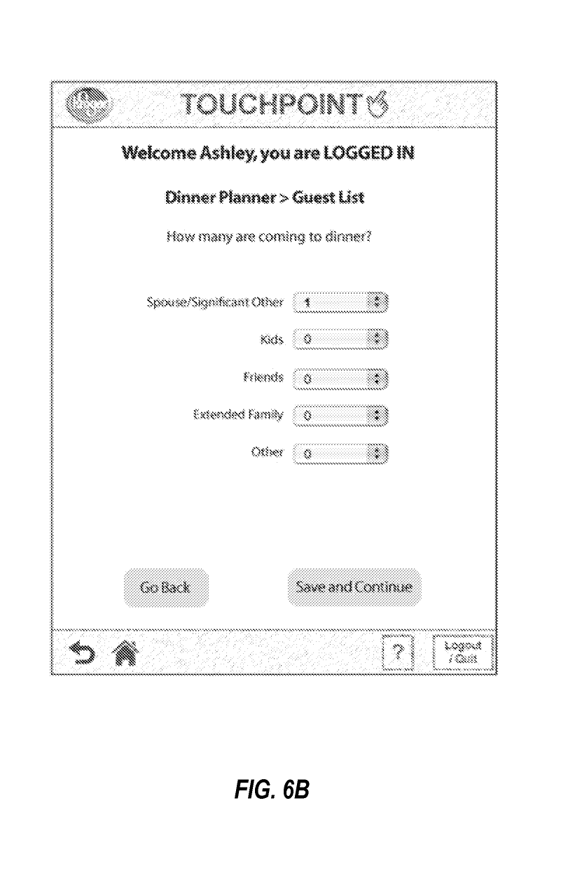

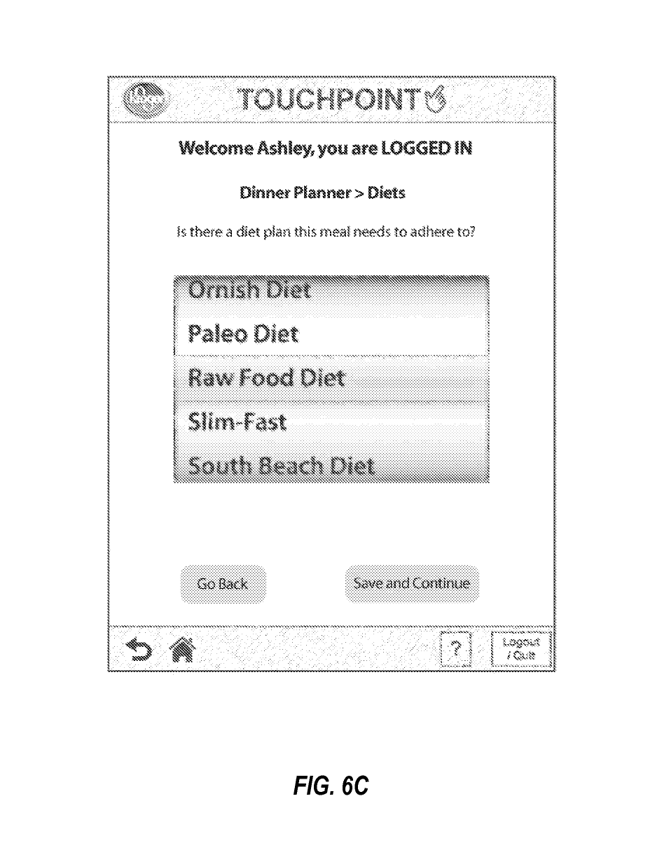

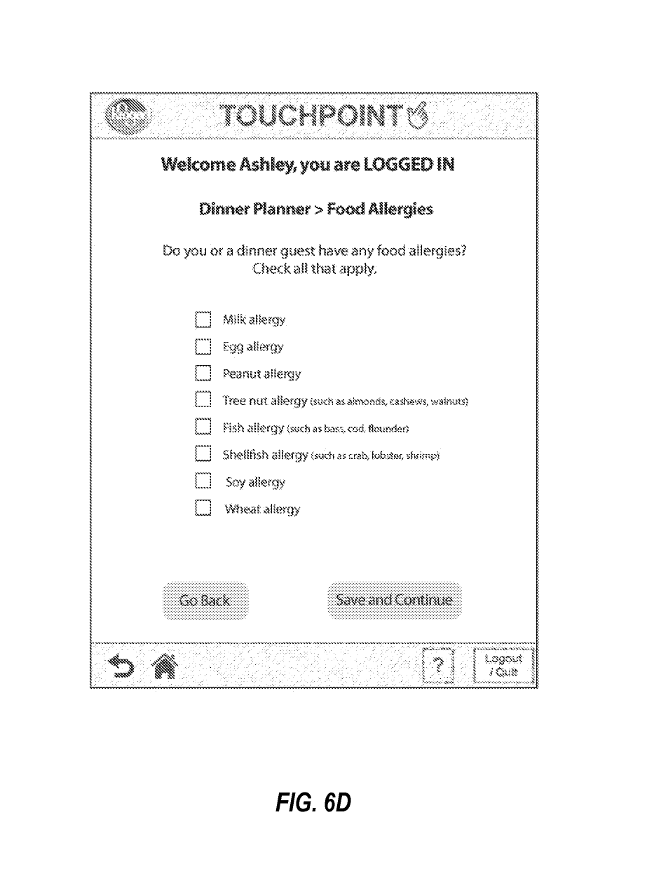

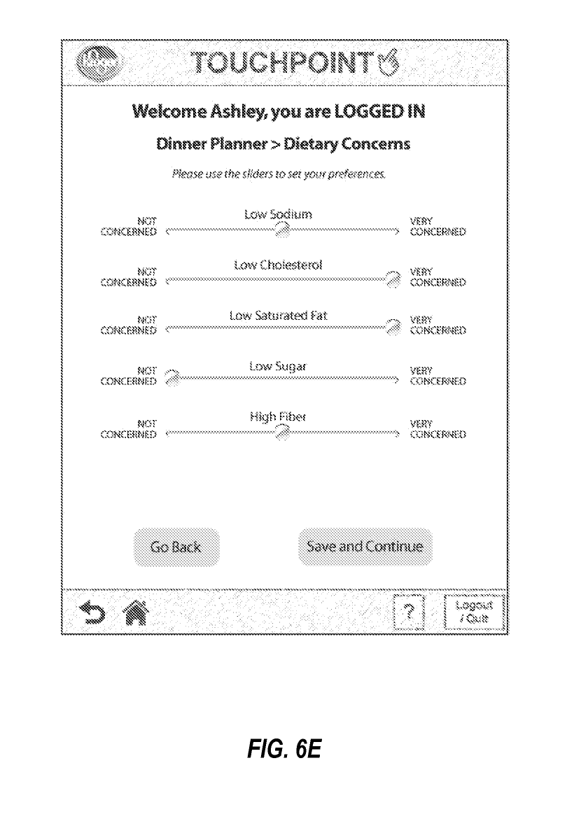

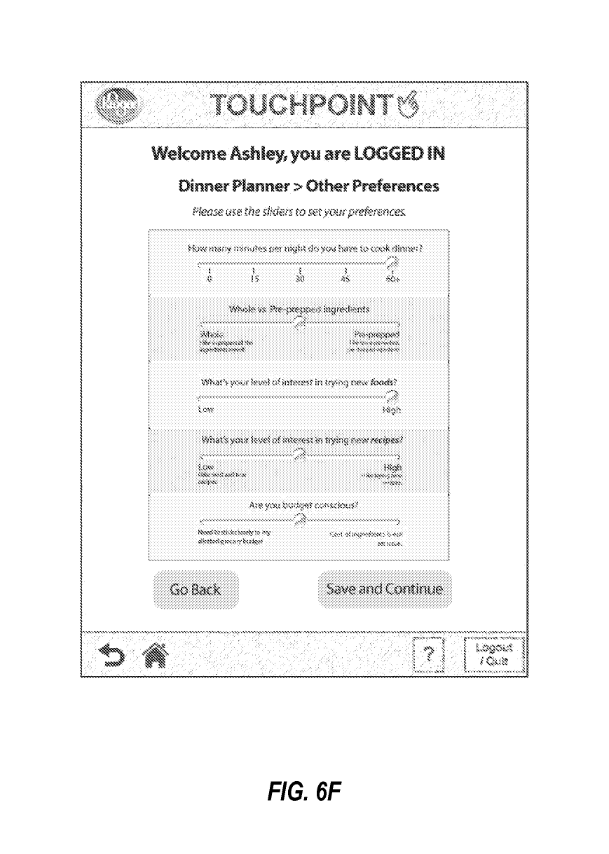

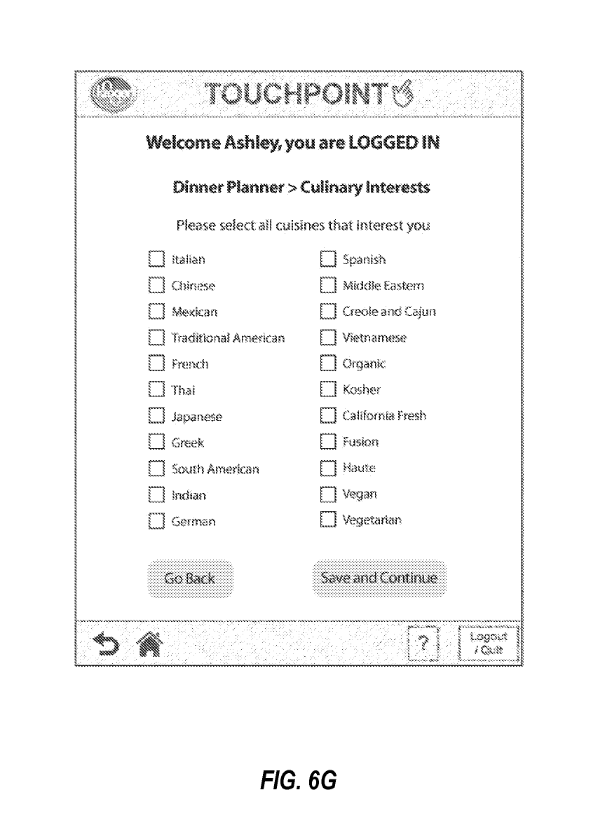

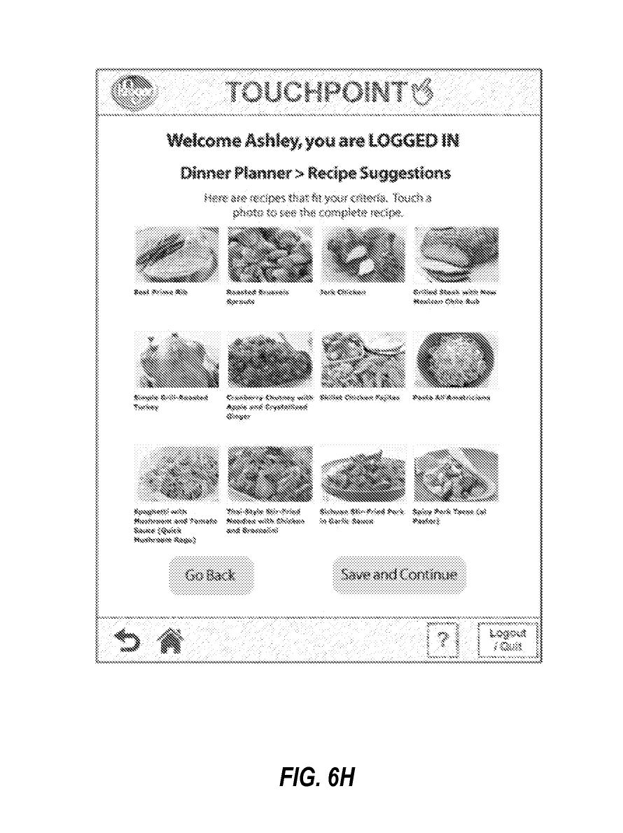

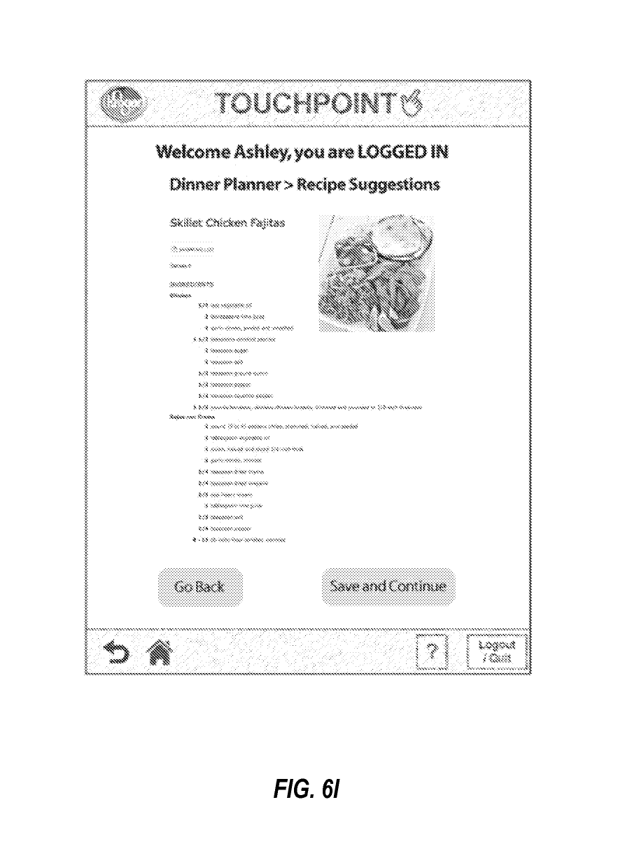

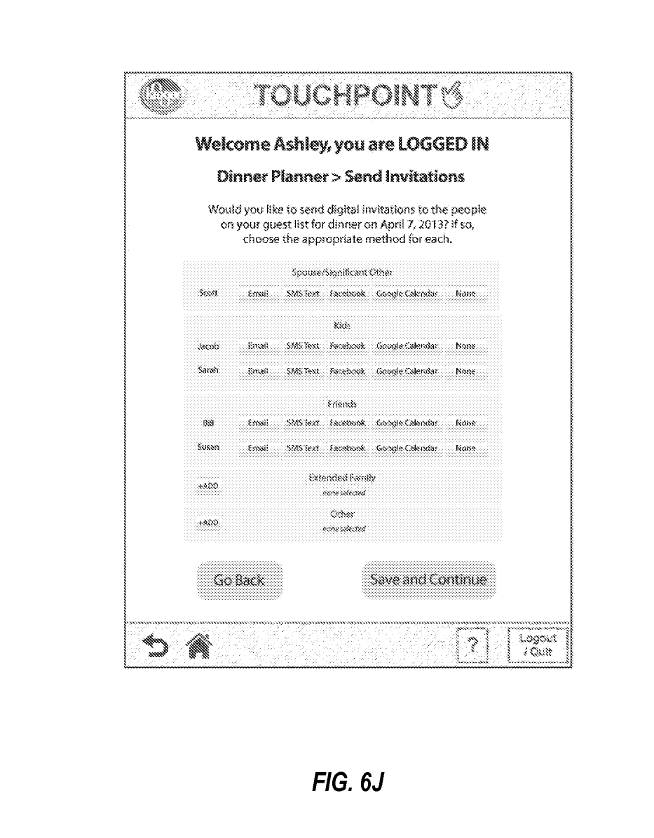

FIGS. 6A-6J illustrate various screenshots of a user interface that can be used to provide recipe suggestions to a consumer and is therefore an example of where a manufacturer or supplier of a product can provide an advertisement for a product required by a recipe. FIG. 6A illustrates that the consumer is given the option to select a date to plan dinner for, while FIG. 6B illustrates that the consumer can specify how many people will be eating the dinner.

FIGS. 6C-6G illustrate various screens that can be used to receive input from the consumer regarding food preferences, interests, or dietary restrictions. Based on input received through these screens, as well as possibly other input or information already obtained from the consumer, one or more recipes can be recommended. FIG. 6H illustrates a screen that displays various recipes that match the consumer's input. When the consumer selects one of the recipes such as the Skillet Chicken Fajitas recipe, the screen shown in FIG. 6I can be displayed which lists the ingredients required to prepare the recipe.

FIG. 6I is one example of where an advertisement for a particular ingredient listed in the recipe can be displayed. For example, the Skillet Chicken Fajitas recipe calls for tortillas. Accordingly, the present invention can allow one or more manufacturers or suppliers of tortillas to present an advertisement (not shown) in conjunction with the display of the screen in FIG. 6I. The advertisement can be selectable to allow the particular brand of tortillas being advertised to be added to a shopping list (e.g. if the consumer decides to select the recipe). Similarly, if the advertisement includes a coupon, the coupon can be added to or otherwise associated with the consumer's shopping list to enable the coupon to be redeemed when the consumer purchases the particular brand of tortillas. Finally, FIG. 6J also illustrates that the user interface can allow the consumer to send invites to any individuals the consumer has indicated will be attending the dinner.

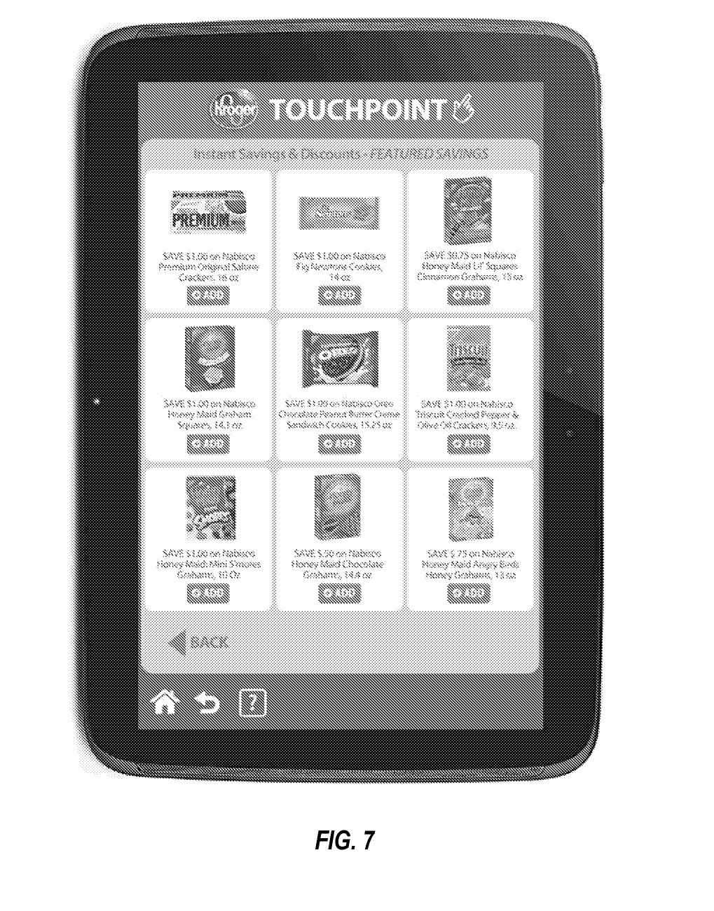

In another example, a consumer may be manually entering products into a shopping list using a computing device (as opposed to receiving shopping list or recipe recommendations). This manual entry can be performed by selecting products displayed within a digital retail store as shown in FIG. 7 or by directly inputting a product (e.g. by typing or speech input). In such cases, the present invention can detect that the consumer has entered a particular type of product for which a manufacturer of the product has requested that advertisements be displayed. In response, the present invention can display an advertisement for the manufacturer's brand of the product in association with the display of the product in the shopping list. In some embodiments, selection of the advertisement may cause the listing of the product in the shopping list to be updated to list the particular brand of the product, or may cause a coupon or other discount to be associated with the shopping list.

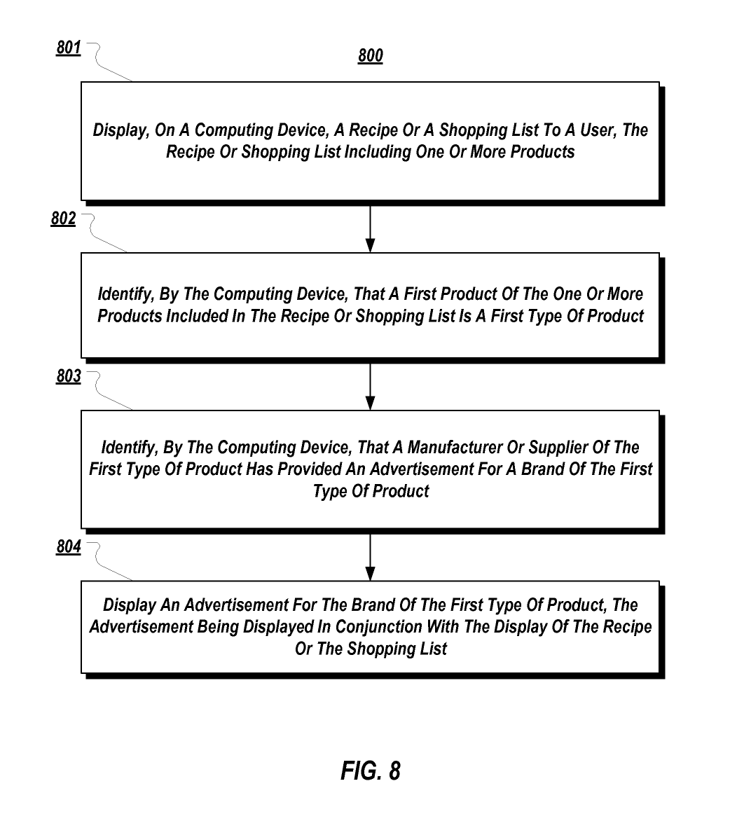

FIG. 8 illustrates a flowchart of an example method 800 for displaying an advertisement of a product to a user in conjunction with the display of the product in a recipe or shopping list. Method 800 can be implemented by one or more computing devices such as a mobile or personal computing device or a mobile or personal computing device in conjunction with a server computing device.

Method 800 includes an act 801 of displaying, on a computing device, a recipe or a shopping list to a user, the recipe or shopping list including one or more products. For example, a user selected recipe, a recipe for a recommended meal, a shopping list containing ingredients of a recommended meal, or a shopping list containing user selected products can be displayed to the user.

Method 800 includes an act 802 of identifying, by the computing device, that a first product of the one or more products included in the recipe or shopping list is a first type of product. For example, it can be identified that the recipe or shopping list includes brown rice.

Method 800 includes an act 803 of identifying, by the computing device, that a manufacturer or supplier of the first type of product has provided an advertisement for a brand of the first type of product. For example, it can be identified that one or more manufacturers of brown rice have provided an advertisement to be displayed when brown rice appears in a recipe or shopping list.

Method 800 includes an act 804 of displaying an advertisement for the brand of the first type of product, the advertisement being displayed in conjunction with the display of the recipe or the shopping list. For example, an advertisement for a particular brand of brown rice can be displayed in conjunction with the display of a recipe or shopping list that includes brown rice.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by one or more computing devices, for displaying an advertisement of a product to a user in conjunction with the display of the product in a recipe or shopping list, the method comprising;
displaying, on a computing device, a recipe or a shopping list to a user, the recipe or shopping list including one or more products;
identifying, by the computing device, that a first product of the one or more products included in the recipe or shopping list is a first type of product;
identifying, by the computing device, that a manufacturer or supplier of the first type of product has provided an advertisement for a brand of the first type of product; and
displaying an advertisement for the brand of the first type of product, the advertisement being displayed in conjunction with the display of the recipe or the shopping list.

2. The method of claim 1, wherein the recipe or shopping list is a recipe, the method further comprising:
determining that the recipe is to be displayed by:
receiving user input that identifies one or more characteristics of the user, the one or more characteristics related to the user's preferences for meals;
identifying information regarding a plurality of meals; and
using the one or more characteristics of the user to identify one or more meals to recommend to the user;
providing a recommendation for at least one of the one or more identified meals; and
receiving user input that selects a first identified meal, wherein the recipe corresponds to the selected meal.

3. The method of claim 2, further comprising:
in response to user input, adding one or more products included in the recipe in a shopping list, the one or more products including the brand of the first type of product.

4. The method of claim 1, further comprising:
receiving user input that selects the advertisement; and
adding the brand of the first type of the product to the shopping list.

5. The method of claim 2, wherein the one or more characteristics comprise one or more of:
an indication that the user enjoys the flavor of one or more meals;
an indication of one or more ingredients that the user enjoys;
an indication of which meals the user prefers at which times of day;
an indication that the user enjoyed a meal that was previously recommended; or
an indication of ingredients the user has available.

6. The method of claim 2, wherein the one or more characteristics comprise a modification that the user made to a meal that was previously recommended.

7. The method of claim 2, wherein the one or more characteristics comprise one or more of:
an indication of an activity that the user engaged in or will engage in before, during, or after consuming a recommended meal;
an indication of a quality of a meal that the user prefers when the meal will be consumed in proximity to an activity the user will engage in; or
an indication of a health goal or dietary goal of the user.

8. The method of claim 2, wherein the information regarding a plurality of meals comprises ingredients of the plurality of meals.

9. The method of claim 2, wherein the information regarding a plurality of meals comprises nutritional information of the plurality of meals.

10. The method of claim 2, wherein the information regarding a plurality of meals comprises feedback received from other users regarding the plurality of meals.

11. The method of claim 10 wherein the feedback includes one or more characteristics of the other users regarding the other users' preferences for meals.

12. The method of claim 2, wherein the information regarding a plurality of meals comprises availability of ingredients required by at least one of the plurality of meals.

13. The method of claim 2, wherein using the one or more characteristics of the user to identify one or more meals to recommend to the user comprises:
matching the one or more characteristics of the user to the information regarding the one or more meals.

14. The method of claim 13, wherein the information regarding the one or more meals comprises feedback provided by the user regarding the one or more meals or one or more related meals.

15. The method of claim 14, wherein the feedback comprises an indication that the user enjoyed a meal having similar ingredients.

16. The method of claim 1, wherein the recipe or shopping list is a shopping list, the method further comprising:
receiving user input that selects the advertisement; and
updating the shopping list to replace a generic listing of the first type of product with the brand of the first type of product.

17. The method of claim 1, further comprising:
receiving user input that selects the advertisement; and
associating a coupon for the brand of the first type of product with an account of the user.

18. The method of claim 1, wherein the recipe or shopping list is a recipe, the method further comprising:
receiving user input that selects the advertisement; and
adding the brand of the first type of product to a shopping list.

19. A method, performed by one or more computing devices, for displaying an advertisement of a product to a user in conjunction with the display of the product in a shopping list, the method comprising;
displaying, on a computing device, a shopping list to a user, the shopping list including one or more products;
identifying, by the computing device, that a first product of the one or more products included in the shopping list is a first type of product;
identifying, by the computing device, that a manufacturer or supplier of the first type of product has provided an advertisement for a brand of the first type of product;
displaying an advertisement for the brand of the first type of product, the advertisement being displayed in conjunction with the display of the shopping list;
receiving user input that selects the advertisement; and
updating the first type of product in the shopping list to include the brand of the first type of product.

20. A method, performed by one or more computing devices, for displaying an advertisement of a product to a user in conjunction with the display of the product in a recipe, the method comprising;
displaying, on a computing device, a recipe to a user, the recipe requiring one or more products;
identifying, by the computing device, that a first product of the one or more products required by the recipe is a first type of product;
identifying, by the computing device, that a manufacturer or supplier of the first type of product has provided an advertisement for a brand of the first type of product;
displaying an advertisement for the brand of the first type of product, the advertisement being displayed in conjunction with the display of the recipe;
receiving user input that selects the advertisement; and
adding the brand of the first type of product to a shopping list.
